(19) United States
(12) Patent Application Publication
(10) Pub. No.: US 2006/0179328 A1
(43) Pub. Date: Aug. 10, 2006

(54) Storage device with separable data protection and method thereof

(76) Inventor: Jia-Yih Lii, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/305,233

(22) Filed: Dec. 19, 2005

(30) Foreign Application Priority Data
Feb. 4, 2005 (TW) 094103616

(51) Int. Cl. H04N 7/16; G06F 12/14; H04L 9/32; G06F 17/30; G06F 11/30; G06F 7/04; G06K 9/00; H03M 1/68; H04K 1/00; H04L 9/00

(52) U.S. Cl. 713/193; 726/26

(57) ABSTRACT

A storage device with separable data protection comprises a plurality of one-time or multiple-time programmable read-only memory (ROM) blocks, and a protection device having a plurality of protection control areas. The plurality of ROM blocks may be programmed individually at different times, and the plurality of ROM blocks may be then encrypted by the plurality of protection control areas selectively and respectively, after each programming is completed.

### FIELD OF THE INVENTION

The present invention is generally related to a storage device and, more particularly, to a storage device with separable data protection and a method thereof.

### BACKGROUND OF THE INVENTION

In a highly competitive market, no companies or factories never devote themselves to develop and protect products for keeping their own competitions; in particular, research results easy to be copied, such as source codes and the like, are necessary to be further protected carefully. FIG. 1 shows a conventional one-time programmable (OTP) processor 100, in which a micro-controller unit 102 is used to process commands and data come from other electronic elements, based on the source codes in a read-only memory (ROM) 104. These source codes are written into the ROM 104 by an external code writer 112, while the data or results of logic operations may be buffered in a random access memory (RAM) 106 by the micro-controller unit 102. For verifying whether the recorded source code is correct, a mechanism of reading out the ROM 104 must be reserved for a code reader 110 to externally read out the source code for verification. This mechanism, however, may also allow the non-innocent third party to steal the source code, thereby a protection device 108 is provided to offer encryption protection to the ROM 104, so as to prevent reading out the source code without admittance.

For a former electronic system, the source code may be written by one company independently due to simpler functions. For the present electronic system with more and more functions, however, it is sometimes unable or unnecessary to do research with respect to source codes of all of the functions by a single company independently, whereby the source codes may be provided by a number of companies, respectively. For instance, a company A devoted itself to develop an OTP MP3 controller with the competition in the decoding and encoding algorithm for MP3. In the company A, for keeping the competition, the ROM 104 must be encrypted by the protection device 108 for the MP3 controller at the factory in order to prevent the stealing of the source code therein. The present protection device 108, however, just provides an overall protection for the ROM 104, in such a way that other source codes are not allowed to be written into the ROM 104 any more after the protection device 108 is started by the company A. For the customer of the company A, such as company B, the protection device 108 of this type is lacking in flexibility, since addition or modification of the functions of this MP3 controller, such as interfacing function, as an example, for the enhancement of its own competition may be impossible, leading to an increase in stock risk.

Therefore, there exists a need for a more flexible storage device.

### SUMMARY OF THE INVENTION

An object of the present invention is to provide a storage device providing respective protection for different memory blocks and a method thereof.

In accordance with the present invention, a storage device with separable data protection comprises a plurality of one-time or multiple-time programmable read-only memory (ROM) blocks, and a protection device having a plurality of protection control areas, in which data or source codes may be written into one or more of the plurality of ROM blocks individually at different times, and one or more of the programmed ROM blocks may be then encrypted by one or more of the plurality of protection control areas after each programming is completed.

In accordance with the present invention, the memory blocks except one or more encrypted ROM blocks may be still used without being affected after this encryption is completed, since one or more of the plurality of ROM blocks may be respectively encrypted.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a conventional one-time programmable (OTP) processor;

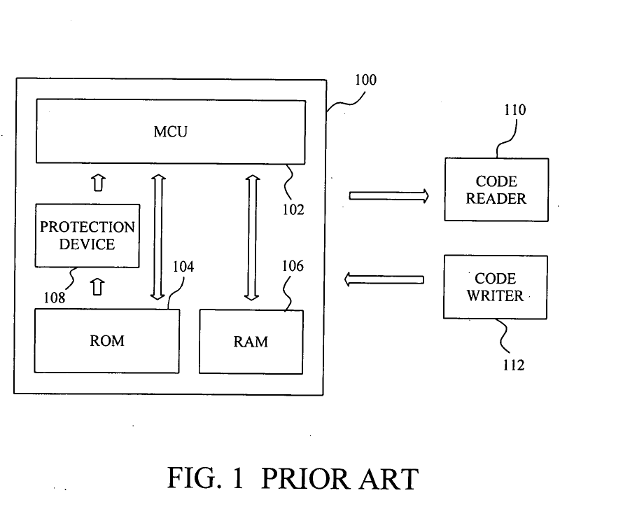

FIG. 2 shows a processor embodying the present invention; and

FIG. 3 shows a MP3 controller embodying the present invention.

### DETAILED DESCRIPTION OF THE INVENTION

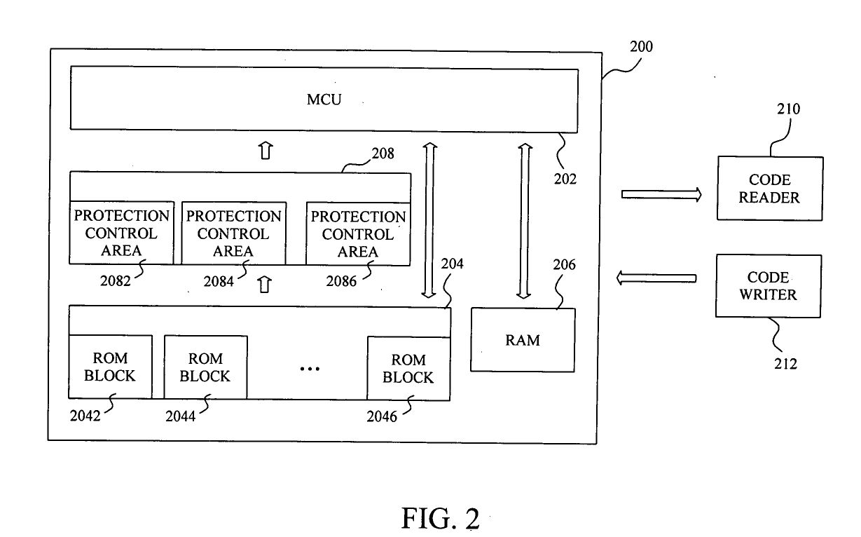

FIG. 2 shows a processor 200 embodying the present invention, in which a micro-controller unit 202 is used to process data based on the source codes programmed in a read-only memory (ROM) 204, while a random access memory (RAM) 206 is provided for the micro-controller unit 202 to buffer the data. The ROM 204 comprises several ROM blocks 2042-2046 into which the source codes may be written by a code writer 212. A protection device 208 is used to encrypt the ROM 204, in order to prevent that the source codes in the ROM 204 may be stolen by any non-innocent third party with an external code reader 210 via a reserved reading mechanism. The protection device 208 includes a plurality of protection control areas 2082-2086 allowed for the separate protection of the ROM blocks 2042-2046 in the ROM 204. When the ROM block 2042 is protected by the corresponding protection control area 2082, the use of other memory blocks 2044-2046 is never affected accordingly, owing to the separation protection with respect to the respective ROM blocks 2042-2046. In this case, the ROM 204 may be either a one-time programmable memory, or a multiple-time programmable memory.

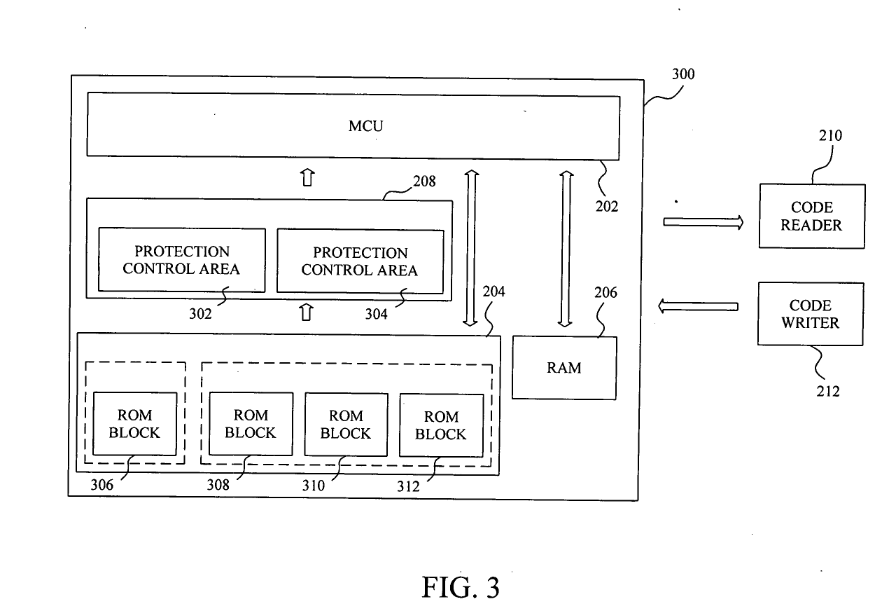

In view of the function of separate protection provided for the storage device of the present invention, source codes with different functions may be developed by the most suitable companies each, while crystallization of the wisdom of each company may be thereby protected, respectively. Referring to FIG. 3, for instance, an MP3 controller 300 is developed by company A, in which the ROM blocks 308, 310, and 312 storing the source codes of the functions, such as frequency-modulation (FM) broadcasting, MP3 encoding, and MP3 decoding, as examples, are encrypted by the protection control area 304 of the protection device 208 when the MP3 controller 300 is sent out of the factory, in order to prevent that the research result of this company may be stolen by any non-innocent third party. Further, the use of the other ROM block 306 in the ROM 204 is not affected when the ROM blocks 308, 310, and 312 are protected by the protection control area 304, due to the fact that the protection provided by the protection control area 304 is independent. Therefore, for company B, after the MP3 controller 300 is purchased from the company A, source codes of the interfacing function and others developed by itself may be written into the ROM block 306 for the enhancement of its own competition, and then encrypted by the protection control area 302 of the protection device 208. As such, the production or development of different functions with the most flexibility, as well as a shortened development period for derivative products and a reduced stock risk may be obtained for the company B.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A storage device with separable data protection, comprising:
a plurality of one-time or multiple-time programmable read-only memory (ROM) blocks; and
a protection device including a plurality of protection control areas, each selectively encrypting one or more of the plurality of ROM blocks.

2. A storage device with separable data protection, comprising:
one or more first read-only memory (ROM) blocks;
one or more second ROM blocks; and
a protection device including a first protection control area for encrypting the first ROM blocks and a second protection control area for encrypting the second ROM blocks.

3. A method for separable data protection for a storage device, comprising the steps of:
providing a plurality of read-only memory (ROM) blocks allowed to be programmed respectively; and
providing a protection device having at least one protection control area allowed to selectively encrypt one or more of the plurality of ROM blocks.

4. A method for separable data protection for a storage device including a plurality of one-time or multiple-time programmable read-only memory (ROM) blocks and a protection device having a plurality of protection control areas thereof, the method comprising the steps of:
programming one or more of the plurality of ROM blocks individually at different times; and
encrypting the one or more of programmed ROM blocks by one of the plurality of protection control areas after each programming is completed.
